(19) United States
(12) Patent Application Publication
(10) Pub. No.: US 2025/0107656 A1
(43) Pub. Date: Apr. 3, 2025

(54) Cooking Appliance

(71) Applicant: SEB S.A., Ecully (FR)

(72) Inventors: Bernard Allemand, Ecully Cedex (FR); Marie DussART, Ecully Cedex (FR); Gautier Fradet, Ecully Cedex (FR)

(73) Assignee: SEB S.A., Ecully (FR)

(21) Appl. No.: 18/898,999

(22) Filed: Sep. 27, 2024

(30) Foreign Application Priority Data
Sep. 29, 2023 (FR) 23/10453

(51) Int. Cl. A47J 37/06; F24C 15/02; F24C 15/04

(52) U.S. Cl. CPC A47J 37/0623; F24C 15/022; F24C 15/04

(57) ABSTRACT

A cooking appliance includes a casing defining an internal cooking space and an opening towards the internal cooking space, a cooking vessel, arranged to be introduced into the internal cooking space through the opening of the casing, and including at least one wall with a transparent window arranged to face the opening of the casing, and a closing wall, arranged to close the opening of the casing when the cooking vessel is in the internal cooking space, and including at least one transparent porthole arranged facing the transparent window. The closing wall is provided to be detachable relative to the cooking vessel, and in that the transparent porthole is permanently mounted on the closing wall.

### CROSS-REFERENCE TO RELATED APPLICATION(S)

The present application claims priority from French Application No. 23/10453, filed on Sep. 29, 2023, all of which is incorporated herein by reference.

### TECHNICAL FIELD OF THE INVENTION

The present invention concerns generally a cooking appliance with a cooking vessel to be introduced into a cooking space, and arranged to allow the visualization of food being cooked in the cooking vessel.

### STATE OF THE ART

It is known in the prior art cooking appliances arranged to allow the visualization of food such as documents CN114515112 or WO202211809. On the other hand, these removable systems can lead to a reduction in the service life of the transparent surfaces and the elements ensuring the seal between the transparent surfaces and the inside of the vessel. Indeed, the extraction and installation of the transparent surfaces on their support requires subjecting them to regular mechanical stresses (friction, twisting, bending, impacts, etc.), which exposes them to a greater risk of breakage and/or to a more rapid deterioration.

### DISCLOSURE OF THE INVENTION

An aim of the present invention is to address the drawbacks of the prior art mentioned above and in particular, first of all, to propose a cooking appliance arranged to allow the visualization of food while guaranteeing an extended service life and maintenance over time of the initial qualities of the appliance.

For this, a first aspect of the invention concerns a cooking appliance comprising at least:
a casing defining in particular an external wall of the cooking appliance, an internal cooking space and an opening towards the internal cooking space,
a cooking vessel, provided for receiving food to be cooked and arranged to be introduced into the internal cooking space through the opening of the casing, and comprising
   at least one wall with a transparent window arranged to face the opening of the casing,
   a closing wall, arranged to close the opening of the casing when the cooking vessel is in the internal cooking space, and comprising at least one transparent porthole arranged facing the transparent window,
cooking means, provided for cooking the food received in the cooking vessel, characterized in that the closing wall is provided to be detachable relative to the cooking vessel, and in that the transparent porthole is permanently mounted on the closing wall. The transparent window and/or the transparent porthole may be made of glass, polycarbonate, transparent synthetic material (polymer for example), transparent mineral material (glass, borosilicate glass, crystal, quartz, etc.). The permanent, in other words fixed and immovable, mounting of the transparent porthole on the closing wall makes it possible to increase the service life of the sealing means present between the transparent porthole and the closing wall and/or the inside of the cooking vessel (for example one or more seal(s)). Such seals being sensitive members of the assembly, they are likely to be stressed and/or damaged during successive mounting and dismounting of a removable transparent window, not to mention the forces applied to the parts (torsion, bending, impacts, falls, etc.) which can lead to breakage. The permanent fastening of the transparent porthole relative to the closing wall makes it possible to protect the transparent porthole from scratches and/or impacts and/or cracks. These assemblies also contribute to making the cooking appliance simple and practical to use. Thus, a permanent mounting means that the porthole is stationary and immovable. The porthole cannot therefore be dismantled by the user without special tools, the aim being to prevent the user from dismantling this porthole.

The cooking appliance may further have one or more of the following characteristics, taken alone or in combination.

According to one embodiment, the closing wall forms a front of the cooking appliance, detachable from the cooking vessel.

According to one embodiment, the cooking appliance comprises coupling means arranged to allow a reversible coupling between the closing wall and the cooking vessel. In other words, the closing wall and the cooking vessel can be separated, thus facilitating their cleaning, particularly with regard to the cooking vessel which receives the food to be cooked during cooking and is therefore exposed to the presence of fatty substances even in vessel recesses that are difficult to access. The cooking vessel alone, which has a more compact shape than when it is fastened to the closing wall, is more practical to install alone in a dishwasher and takes up less space. The closing wall can be mounted on the casing, even when it is not fastened to the vessel, ensuring a compact cooking appliance adaptable to the user's needs. It is also possible to provide a specific material for the transparent porthole that is less resistant and/or cheaper because it is not necessary to guarantee (for the closing wall and/or for the transparent porthole) a resistance to dishwashers and to high washing temperatures.

According to one embodiment, if the vessel is not present in the casing, the cooking appliance will not start. In particular, the cooking appliance comprises a control unit and detection means provided to verify a presence of the cooking vessel, independently of the presence of the closing wall, so as to prohibit a start and/or an operation of the cooking appliance if the cooking vessel is detected to be absent or incorrectly mounted.

According to one embodiment, the coupling means comprise:
at least one location index provided on one of the cooking vessel and the closing wall and a location imprint provided on the other of the cooking vessel and the closing wall and arranged to couple together reversibly,
at least one attachment index provided on one of the cooking vessel and the closing wall and a movable attachment counterform provided on the other of the cooking vessel and the closing wall and arranged to attach together reversibly.

The dissociation of the guidance/location and fastening functions ensures a good holding of the coupling mechanism. The location index also makes coupling the front to the vessel easier and more intuitive for the user.

According to one embodiment, when the cooking vessel is coupled to the closing wall, at least one of said at least one location index and of said at least one attachment index is arranged to simultaneously contact the transparent window (for example at least one edge of the transparent window) and the transparent porthole (for example at least one edge of the transparent porthole). Thus, the same member (the location index or the attachment index) contacts the transparent window and the transparent porthole to ensure a direct relative positioning, which provides a precise alignment between these parts that can be dismantled from each other.

According to one embodiment, the coupling means comprise a frame supporting:
said at least one location index, and preferably two location indexes,
said at least one attachment index.

According to one embodiment, the frame supports the transparent window on the cooking vessel. The frame is separate from the body of the cooking vessel. The frame therefore directly positions the transparent window and the relative position between the transparent window and the transparent porthole is improved, and/or more precise.

According to one embodiment, the cooking appliance comprises locking means arranged to occupy:
a locking state in which the closing wall is locked on the cooking vessel,
an unlocking state in which the closing wall can be freely detached from the cooking vessel. The locking state ensures that the front is maintained to the vessel. It is easy to couple the closing wall with the cooking vessel to manipulate the latter, and to release it to, for example, place the cooking vessel in the dishwasher or refrigerator, and to close the opening of the casing with the closing wall alone.

According to one embodiment, the locking means comprise a locking control interface arranged outside the external wall. Thus, the control interface is quickly accessible.

According to one embodiment, the locking control interface comprises a trigger to be actuated by a user, and the locking means comprise elastic return means arranged to return the trigger to a locking position, a movable lock arranged to reversibly lock the closing wall on the cooking vessel and a transmission mechanism arranged between the trigger and the movable lock. The elastic return means ensure a stable maintenance of the vessel on the closing wall, and a safety means, such that the locking means are by default in a locking state relative to the vessel and to prevent an unlocking state from occurring involuntarily or inadvertently.

According to one embodiment, the locking means are arranged to lock the attachment index with the movable attachment counterform.

According to one embodiment, the movable attachment counterform forms a movable lock or a movable bolt.

According to one embodiment, the attachment index comprises or forms a receiving form, and/or a striker, and/or a female form arranged to receive the movable attachment counterform formed by a lock or a bolt.

According to one embodiment, the movable attachment counterform forms the movable lock.

According to one embodiment, the cooking appliance comprises means for gripping the cooking vessel arranged outside the external wall when the cooking vessel is in the internal cooking space. The gripping means must allow the cooking vessel to be manipulated, particularly during or at the end of cooking, and are easily accessible.

According to one embodiment, the means for gripping the cooking vessel are embedded on the closing wall. Thus, the cooking vessel and the closing wall being coupled and locked together by the locking means, the gripping means make it possible to grip the cooking vessel, through the closing wall, in a safe and reliable manner, particularly at the end of cooking when the vessel and its contents may present risks of burns.

According to one embodiment, the gripping means are formed by a handle attached to the closing wall, which is an ergonomic and intuitive means for displacing the cooking vessel.

According to one embodiment, the locking control interface is embedded on the means for gripping the cooking vessel, making the operation of the locking means faster and more ergonomic. It can be envisaged that the locking control interface, the trigger, is arranged on one end of the gripping means, a handle, so that the trigger can be actuated by the user's thumb quickly and intuitively when placing and removing the cooking vessel.

According to one embodiment, the closing wall is provided to form a heat-insulating space between the transparent window and the transparent porthole. In other words, the closing wall is provided to form an air gap between the transparent window and the transparent porthole. Since the air present between the two transparent surfaces is particularly insulating, this embodiment makes it possible to maintain a temperature on the outer wall of the casing, and particularly on the closing wall, that does not present a risk of burns.

According to one embodiment, the cooking appliance comprises a sealed vessel cover. The vessel cover is arranged to fit over the cooking vessel in order to be able to store food therein in the refrigerator.

According to one embodiment, the cooking vessel has a generally rectangular form. In addition, the simple form of the vessel allows it to fit easily on a shelf and among other parallelepiped containers. The cooking appliance is arranged to prevent cooking from starting when the vessel cover is on the vessel and the vessel is in the casing. It is also possible to provide a physical obstacle that prevents the cooking vessel from being mounted while its cover is still on.

### DESCRIPTION OF THE FIGURES

Other features and advantages of the present invention will become more apparent upon reading the following detailed description of an embodiment of the invention given as a non-limiting example and illustrated by the appended drawings, in which:

FIG. 1 represents an isometric view of a cooking vessel coupled to a closing wall of a cooking appliance;

FIG. 2 represents an isometric view of the cooking vessel decoupled from the closing wall of the cooking appliance;

FIG. 3 represents a sectional view of the assembly between the closing wall and the cooking vessel of FIG. 1, at locking means being in a locked state;

FIG. 4 represents a sectional view of FIG. 3 with the locking means in an unlocked state.

### DETAILED DESCRIPTION OF EMBODIMENT(S)

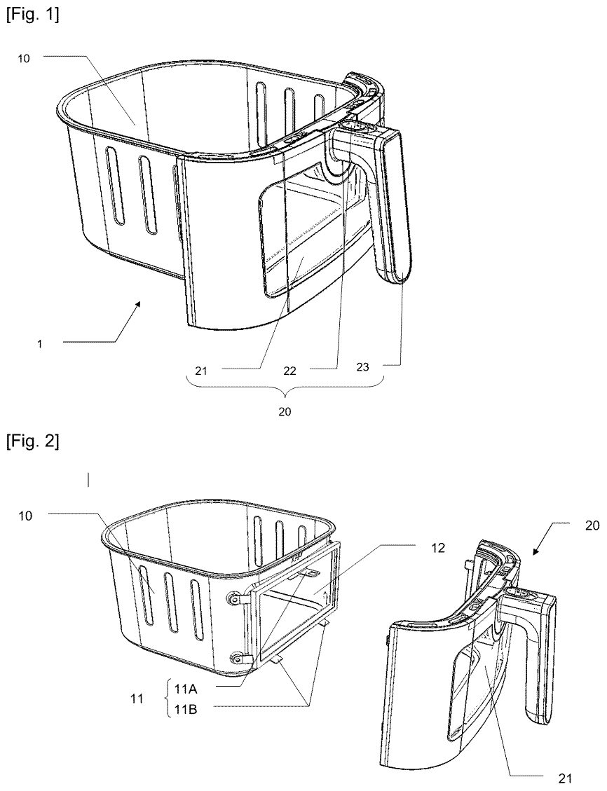

FIG. 1 represents a subassembly 1 of a cooking appliance, formed by a cooking vessel 10 coupled to a closing wall 20, and arranged to introduce or remove food from a cooking space provided in a cooking appliance.

The cooking vessel 10 is intended to receive the food to be cooked and to be introduced into an internal cooking space of a casing of the cooking appliance (not represented) through an opening provided in the casing of the cooking appliance.

The closing wall 20 comprises gripping means 23, here in the form of a handle, in order to manipulate the subassembly 1, particularly the cooking vessel 10 which contains the food to be cooked and may have a wall temperature high enough to be dangerous during or shortly after cooking. The handle represented therefore provides a thermally insulated manipulation interface.

The closing wall 20 also comprises a locking control interface, here in the form of a trigger 22, which, when actuated by a user, is arranged to unlock and detach the closing wall 20 from the cooking vessel 10. The trigger 22 is arranged in sliding connection relative to the gripping means 23 and to the rest of the closing wall 20.

Finally, the closing wall 20 comprises a transparent porthole 21 allowing the food in the cooking vessel 10 to be viewed from outside the casing during cooking.

FIG. 2 represents the subassembly of FIG. 1 dismantled, with the cooking vessel 10 detached from the closing wall 20. In order to enable viewing of the interior of the cooking vessel 10 during cooking from the outside, the vessel 10 comprises a transparent window 12 provided to be located facing or opposite the transparent porthole 21 of the closing wall 20.

Two location indexes 11B and an attachment index 11A are arranged on a frame of the transparent window 12, forming coupling means 11 allowing the reversible coupling of the work vessel 10 with the closing wall 20.

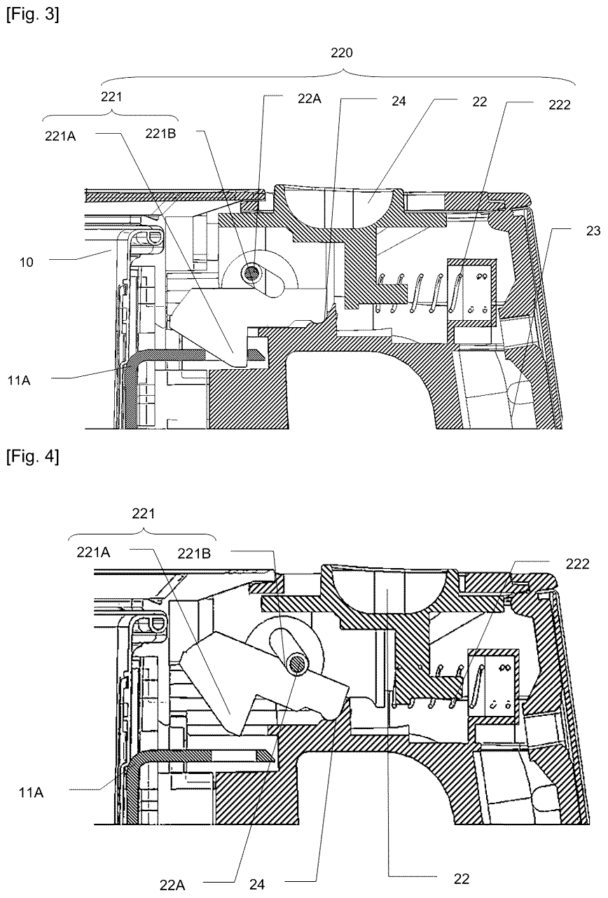

FIG. 3 represents a section of the gripping means 23 of FIG. 1, to show a mechanism for assembling/locking the closing wall 20 to the cooking vessel 10, forming locking means 220. The locking means comprise:
the trigger 22, comprising a pin 22A,
elastic return means, such as a spring 222, arranged in the gripping means 23, between the trigger 22 and a wall of the gripping means 23,
a movable lock 221 having an inclined oblong hole receiving the pin 22A,
a stop 24, housing a circular counterform of the movable lock 24,
an attachment index 11A of the cooking vessel 10 comprising an orifice forming a striker receiving a hook 221A of the movable lock 221.

The elastic return means, such as a spring 222, maintain the trigger 22 in a locking position represented in FIG. 3, such that the locking means 220 are by default in a locking state in the absence of a control action exerted on the trigger 22. The movable lock 221 secured to the closing wall 20 is locked in the attachment index 11A of the cooking vessel 10, by means of an attachment counterform or of a hook 221A housed in the striker or the orifice provided in the attachment index 11A.

The movable lock 221 is arranged in sliding connection with a pin 22A secured to the trigger 22: the pin 22A can move in the oblong hole 221B of the movable lock 221, elongated in a direction of elongation inclined relative to the direction of displacement imposed by movements of the trigger 22. In addition, the lock 221 comprises a rounded counterform resting on a stop 24.

Consequently, as illustrated in FIG. 4, when the trigger 22 is actuated, therefore pulled to the right of FIG. 4, it compresses the spring 222. Its rectilinear translation drives the pin 22A in the same direction, so that the latch 221, in abutment on the stop 24, tilts as represented in FIG. 4. The rounded and complementary forms of the stop 24 and of the movable latch 221 facilitate the pivoting of the latch around the stop 24; the oblong hole 221B and the pin 22A have a relative sliding movement; the hook 221A is no longer engaged with the attachment index 11A and the cooking vessel 10 can be separated from the closing wall 20.

### INDUSTRIAL APPLICATION

A cooking appliance according to the present invention, and its manufacture, are capable of industrial application.

It will be understood that various modifications and/or improvements obvious to those skilled in the art can be made to the different embodiments of the invention described in the present description without departing from the scope of the invention. In particular, it can be noted that the trigger 22 can be actuated according to movements other than a translation caused by a pull from the user. Compression, tilting, pivoting can be provided. The position of the trigger 22 can vary, for example by being placed under the handle or on the side, so that it can be easily manipulated by fingers other than the user's thumb when gripping the handle.

1. A cooking appliance comprising:
a casing defining an external wall of the cooking appliance, an internal cooking space and an opening towards the internal cooking space,
a cooking vessel for receiving food to be cooked and arranged to be introduced into the internal cooking space through the opening of the casing, and comprising:
at least one wall with a transparent window arranged to face the opening of the casing, and
a closing wall, arranged to close the opening of the casing when the cooking vessel is in the internal cooking space, and comprising at least one transparent porthole arranged facing the transparent window, cooking means for cooking the food received in the cooking vessel,
wherein the closing wall is configured to be detachable relative to the cooking vessel, and wherein the transparent porthole is permanently mounted on the closing wall.

2. The cooking appliance according to claim 1, wherein the closing wall forms a front of the cooking appliance, detachable from the cooking vessel.

3. The cooking appliance according to claim 1, further comprising coupling means configured to allow a reversible coupling between the closing wall and the cooking vessel.

4. The cooking appliance according to claim 3, wherein the coupling means comprise:
at least one location index provided on one of the cooking vessel and the closing wall and a location imprint provided on other of the cooking vessel and the closing wall and arranged to couple together reversibly, and
at least one attachment index provided on one of the cooking vessel and the closing wall and a movable attachment counterform provided on other of the cooking vessel and the closing wall and arranged to attach together reversibly.

5. The cooking appliance according to claim 4, wherein the coupling means comprise a frame supporting:
said at least one location index, or two location indexes, and
said at least one attachment index.

6. The cooking appliance according to claim 5, wherein the frame supports the transparent window on the cooking vessel.

7. The cooking appliance according to claim 1, further comprising locking means arranged to occupy:
a locking state in which the closing wall is locked on the cooking vessel, and
an unlocking state in which the closing wall is freely detached from the cooking vessel.

8. The cooking appliance according to claim 7, wherein the locking means comprise a locking control interface arranged outside the outer wall.

9. The cooking appliance according to claim 8, wherein the locking control interface comprises a trigger to be actuated by a user, and wherein the locking means comprise elastic return means arranged to return the trigger to a locking position, a movable lock arranged to reversibly lock the closing wall on the cooking vessel and a transmission mechanism arranged between the trigger and the movable lock.

10. The cooking appliance according to claim 7, further comprising coupling means configured to allow a reversible coupling between the closing wall and the cooking vessel,
wherein the coupling means comprise:
at least one location index provided on one of the cooking vessel and the closing wall and a location imprint provided on other of the cooking vessel and the closing wall and arranged to couple together reversibly, and
at least one attachment index provided on one of the cooking vessel and the closing wall and a movable attachment counterform provided on other of the cooking vessel and the closing wall and arranged to attach together reversibly, and
wherein the locking means are arranged to lock the attachment index with the movable attachment counterform.

11. The cooking appliance according to claim 10,
wherein the locking means comprise a locking control interface arranged outside the outer wall,
wherein the locking control interface comprises a trigger to be actuated by a user, and wherein the locking means comprise elastic return means arranged to return the trigger to a locking position, a movable lock arranged to reversibly lock the closing wall on the cooking vessel and a transmission mechanism arranged between the trigger and the movable lock, and
wherein the movable attachment counterform forms the movable lock.

12. The cooking appliance according to claim 1, further comprising means for gripping the cooking vessel arranged outside the external wall when the cooking vessel is in the internal cooking space.

13. The cooking appliance according to claim 12, wherein the means for gripping the cooking vessel are embedded on the closing wall.

14. The cooking appliance according to claim 12, wherein the gripping means are formed by a handle attached to the closing wall.

15. The cooking appliance according to claim 12, further comprising locking means arranged to occupy:
a locking state in which the closing wall is locked on the cooking vessel, and
an unlocking state in which the closing wall is freely detached from the cooking vessel,
wherein the locking means comprise a locking control interface arranged outside the outer wall, and
wherein the locking control interface is embedded on the means for gripping the cooking vessel.

16. The cooking appliance according to claim 1, wherein the closing wall is provided to form a heat-insulating space between the transparent window and the transparent porthole.
